(19) United States
(12) Patent Application Publication
(10) Pub. No.: US 2012/0097101 A1
(43) Pub. Date: Apr. 26, 2012

(54) Modularly Integrated Coating Systems

(75) Inventor: Brent Allen Schwartz, Wapakoneta, OH (US)

(73) Assignee: METOKOTE CORPORATION, Lima, OH (US)

(21) Appl. No.: 13/093,266

(22) Filed: Apr. 25, 2011

Related U.S. Application Data
(60) Provisional application No. 61/327,166, filed on Apr. 23, 2010.

(51) Int. Cl. B05C 9/14; B05C 13/00; C25D 21/02; B05C 11/00

(52) U.S. Cl. 118/696; 204/241

(57) ABSTRACT

Modularly integrated coating systems for coating a plurality of parts include a part handling system that transports parts between one or more modular ovens configured to modularly connect to one another to form a single curing station of selectable size for curing the plurality of parts, wherein the one or more modular ovens comprise a gas burner and a circulating fan, one or more modular support equipment platforms configured to stackably support the one or more modular ovens in the modularly integrated coating system, wherein the one or more modular support equipment platforms comprises, a water treatment system, a water heat generation system, an integrated lab kit module, and an integrated process control system, and a part coating system operationally integrated with the one or more modular ovens and the one or more modular support equipment platforms, wherein the part coating system coats the plurality of parts.

### CROSS-REFERENCE TO RELATED APPLICATIONS

This application claims priority to U.S. Provisional Application Ser. No. 61/327,166 filed Apr. 23, 2010, which is incorporated by reference herein in its entirety.

### TECHNICAL FIELD

The present specification generally relates to modularly integrated coating systems for coating a plurality of parts and, more specifically, for adaptively providing a coating system for coating a plurality of parts.

### BACKGROUND

A variety of different coating systems containing various selectable features can be used to coat a plurality of parts through processes such as electrocoating or powder coating. As would be familiar to one skilled in the art, the parts may comprise various materials, for example, metal parts utilized in various industries e.g., the automotive industry. In such processes, the plurality of parts must at least be prepared, rinsed, coated and cured while being transported through the coating system by a part conveyor. However, such coating systems are often custom designed and/or built for a specific location and may provide little to no flexibility or re-deployability. Additionally, it may become difficult to selectively include various adaptable features when such coating systems are custom built for each unique location.

Accordingly, a need exists for alternative modular coating systems for coating a plurality of parts.

### SUMMARY

In one embodiment, a modularly integrated coating system for coating a plurality of parts is provided. The modularly integrated coating system includes a part handling system that transports parts between one or more modular ovens configured to modularly connect to one another to form a single curing station of selectable size for curing the plurality of parts, wherein the one or more modular ovens comprise a gas burner and a circulating fan, and one or more modular support equipment platforms configured to stackably support the one or more modular ovens in the modularly integrated coating system. The one or more modular support equipment platforms can include a water treatment system configured to treat water utilized for coating the plurality of parts in the modularly integrated coating system, a water heat generation system configured to provide heated water utilized in coating the parts, an integrated lab kit module configured to provide testing capabilities at one or more points along the modularly integrated coating system, and an integrated process control system configured to monitor and control the coating of the plurality of parts as they progress through the modularly integrated coating system. The part handling system can further transport parts to a part coating system that is operationally integrated with the one or more modular ovens and the one or more modular support equipment platforms, wherein the part coating system coats the plurality of parts.

These and additional features provided by the embodiments described herein will be more fully understood in view of the following detailed description, in conjunction with the drawings.

### BRIEF DESCRIPTION OF THE DRAWINGS

The following detailed description of specific embodiments of the present invention can be best understood when read in conjunction with the following drawings, where like structure is indicated with like reference numerals and in which:

FIG. 1A depicts a front view of an exemplary modularly integrated coating system according to one or more embodiments shown and described herein;

FIG. 1B depicts a rear view of an exemplary modularly integrated coating system according to one or more embodiments shown and described herein;

FIG. 2 depicts an exploded view of one design layout of modular ovens according to one or more embodiments shown and described herein;

FIG. 3 depicts an exploded view of another design layout of modular ovens according to one or more embodiments shown and described herein;

FIG. 4 depicts an exemplary modularly integrated coating system with a part handling system and a coating station according to one or more embodiments shown and described herein; and

FIG. 5 depicts an schematic layout of a modularly integrated coating system according to one or more embodiments shown and described herein.

### DETAILED DESCRIPTION

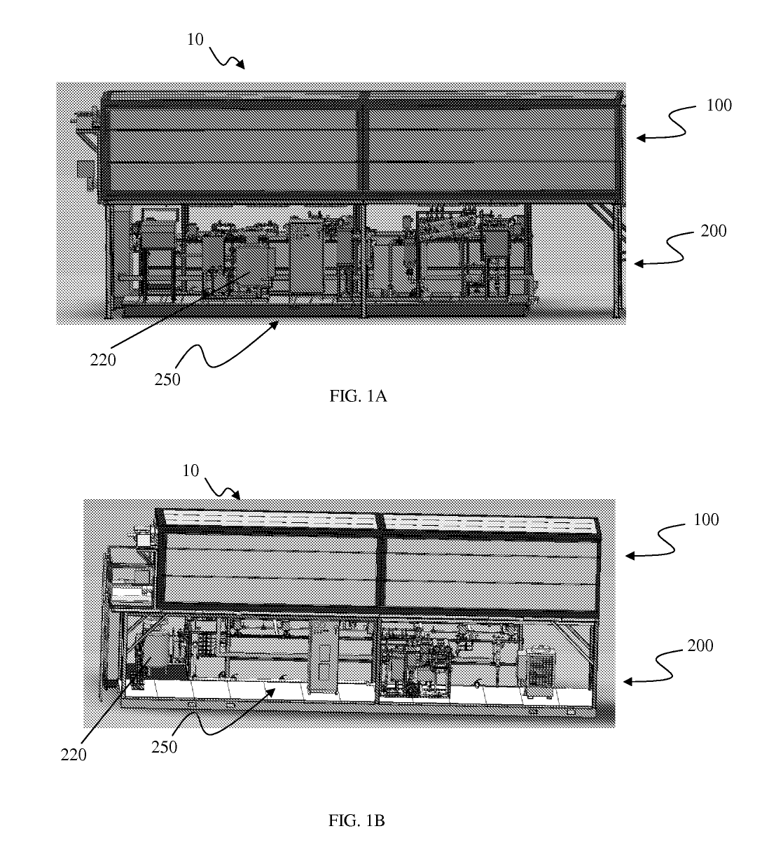

FIGS. 1A and 1B generally depict one exemplary embodiment of a modularly integrated coating system comprising two modular ovens stackably supported by a modular support equipment platform. The modular ovens can be flexibly combined with additional modular ovens in various configurations to provide ovens of desired size and length to achieve any desired curing requirements. The modular support equipment platforms can comprise a plurality of coating equipment such as, for example, water treatment systems, water heat generation systems, coating systems, part conveyor systems, integrated lab kit modules, and/or integrated process control systems such that one or more of the modular support equipment platforms can be combined with one or more of the modular ovens to provide a transportable, flexible and adaptable modularly integrated coating system. Various embodiments of the modularly integrated coating system and the operation thereof will be described in more detail herein.

Referring now to FIGS. 1A and 1B, a modularly integrated coating system 100 can generally comprise one or more modular ovens 100 that modularly connect to one another and one or more modular support equipment platforms 200 that can stackably support the one or more modular ovens 100. As used herein, “modularly connect” means operable to connect with other parts through a standard connection such that multiple different parts may be interchanged (i.e., connected/disconnected) through the modular connection. Also as used herein, “stackably support” means the modular oven 100 can rest on top of and be integrated with the modular support equipment platform such that the equipment contained in the modular support equipment platform 200 can be functionally combined with the modular oven 100.

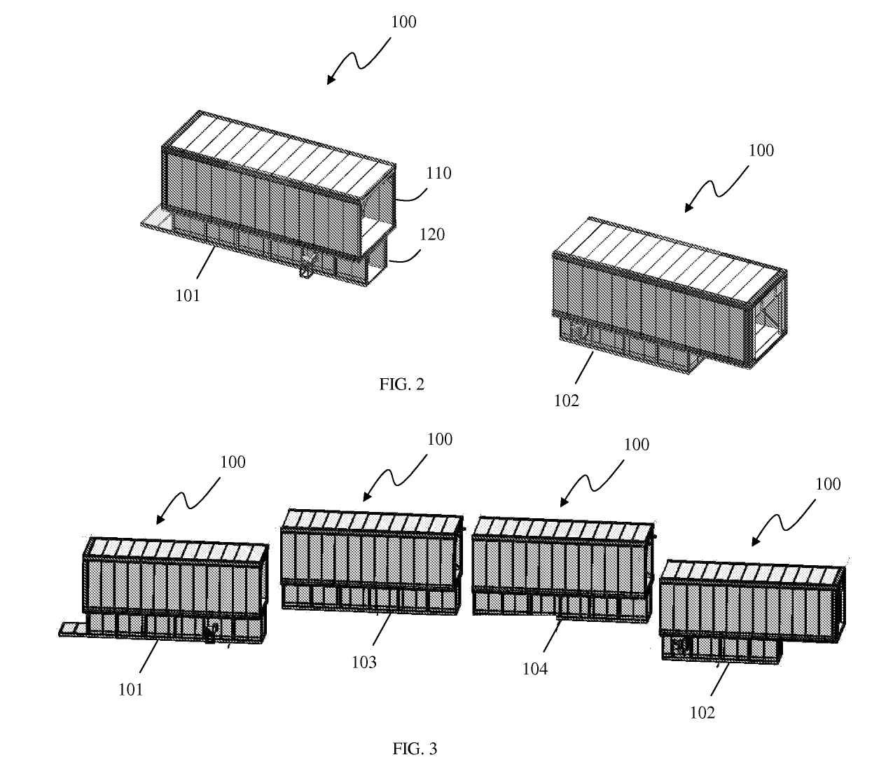

Referring now to FIG. 2, the modular oven 100 can generally comprise a top section 110 and a bottom section 120. The top section 110 can comprise a part heating area where a plurality of parts may pass through and be subjected to heat as can be required during part preparation and/or curing. The bottom section 120 can comprise a support equipment area in which one or more pieces of equipment may be housed. Such equipment can include, for example, circulating fans, burners (e.g., gas burners) or other heat sources, temperature monitors and/or controls, gas lines, part conveyor equipment or any other equipment that may be required for the operation of the modular oven 100. In some embodiments, the modular oven may be operated at a temperature ranging from about 150° C. to about 250° C., or from about 190° C. to about 205° C. Furthermore, each modular oven 100 may be consistently sized and shaped to facilitate its convenient shipment via truck, rail or similar modes of transportation.

Each modular oven 100 can stackably rest on top of a modular support equipment platform 200 and be secured via bolts, screws, brackets or the like. Furthermore, the modularly integrated coating system 10 can utilize any number of modular ovens 100 to create the necessary size and length needed for coating (e.g., curing) a plurality of parts. For example, in one embodiment, such as that illustrated in FIG. 2, the modularly integrated coating system 10 can comprise two modular ovens 100 in series such that length of the overall oven is effectively doubled. In such an embodiment, a first end section 101 (i.e., a modular oven 100 on one end) may comprise a circulating fan while a second end section 102 (i.e., a modular oven 100 on the other end, opposite from the first end section) may comprise a burner, such as a gas burner. In such an embodiment, the plurality of modular ovens may thus combine to form a single curing station for the part coating process.

In another embodiment, such as that illustrated in FIG. 3, additional modular ovens 100 may be integrated between the first end section 101 and second end section 102. Such additional modular ovens, or middle extension sections 103,104, may thereby provide additional length to the overall oven system such that curing time may be extended during the part coating process. Similar to the embodiment illustrated in FIG. 2, the first end section may still comprise a circulating fan and the second end extension may still comprise a burner, such as a gas burner. Thus, the middle extension sections 103, 104 may utilize the features of the two end sections to effectively provide additional space and length while limiting overall costs. In further contemplated embodiments, the middle extension may comprise additional heating elements.

While the embodiments in FIGS. 2 and 3 illustrate combining a plurality of modular ovens 100 in series (i.e., connected end-to-end), it should be appreciated that other flexible design layouts may additionally or alternatively be employed. For example, in some embodiments, the modular ovens may be combined side-by-side to double the width of the overall oven system. In some embodiments, the modular ovens 100 may be combined on top of one another to double the vertical height of the overall oven system. In some embodiments, the modular ovens 100 may be combined in a variety of design layouts to satisfy the specific demands of the modularly integrated coating system which can be influenced by part size, required cure time, available facility space, costs, etc.

Referring again to FIGS. 1A and 1B, the modularly integrated coating system 10 may further comprise a plurality of other coating support equipment 250 that are modularly adaptable for inclusion and that can facilitate the desired coating process for a variety of parts. For example, the modularly integrated coating system 10 can comprise one or more modular support equipment platforms 200 that not only stackably support one or more modular ovens 100, but also house and integrate a plurality of additional coating support equipment 250. Thus, at least some of the additional coating support equipment 250 can be combined into the one or more modular support equipment platforms 200 such that the modular assembly of such modular support equipment platforms 200 can provide for the efficient installation of a variety of coating support equipment 250 by simply installing a single modular support equipment platform 200. Thus, by providing one or more pieces of coating support equipment 250 in the one or more modular support equipment platforms 200, the modularly integrated coating system 10 may provide a plurality coating technologies that may be selectable by a user on demand

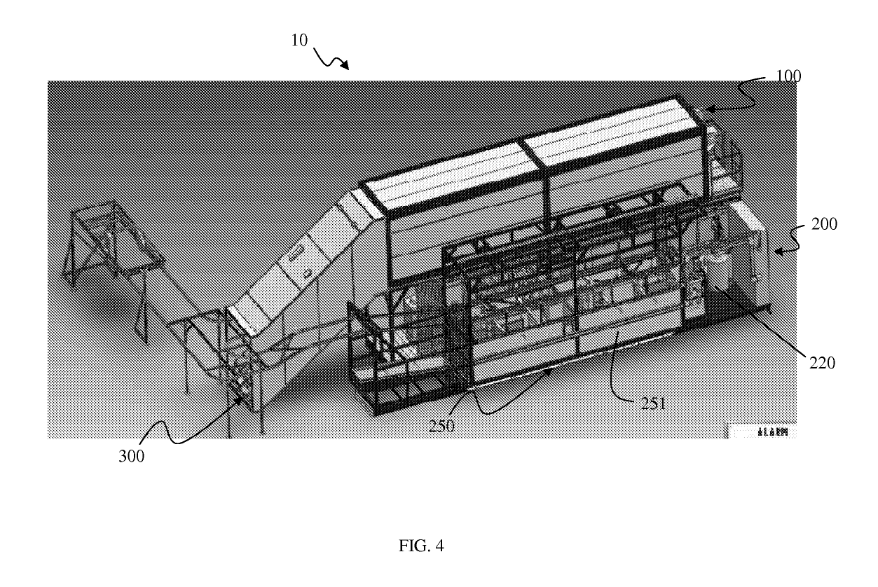

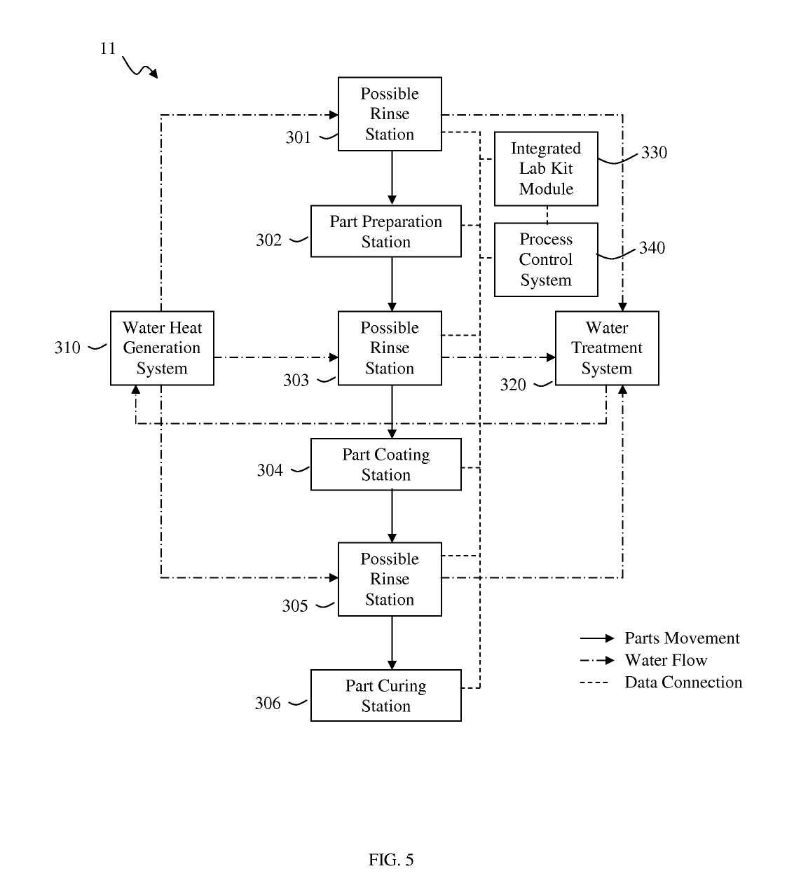

For example, referring to FIGS. 4 and 5, in one embodiment, the modularly integrated coating system 10 may further comprise a plurality of coating support equipment 250 such as a pretreatment system, a coating system, a heating generation system, a waste water system, a water recycle and recovery system, a purified water system, a process control system, and/or a part handling system. It is also contemplated that the modularly integrated coating system may comprise any combination of the above systems to suit the needs of the particular application. The modularly integrated coating system 10 may also comprise additional spray cleaners, ovens, permeate sprayers, and other units suitable to the desired application. In some embodiments, the modularly integrated coating system 10 may also comprise integrated part tipping such as robotic arms that reorient (e.g., rotate or flip) parts for the coating process.

In some embodiments, the modularly integrated coating system 10 may also comprise a pretreatment system (such as initial possible rinse station 301 and/or part preparation station 302). The pretreatment system may be operable to clean, seal, and rinse the part before the coating system operation is commenced. It is also contemplated that the pretreatment system may include devices and units suitable to provide such pretreatment. The pretreatment system may be integrated into the overall coating system to provide a seamless transition.

Referring still to FIG. 4, the modularly integrated coating system 10 may comprise a part coating system 251 that comprises tanks, pumps, anodes, anolyte systems, rectifiers, cooling systems, and/or ultra-filtration systems. The part coating system 251 can be operationally integrated with the one or more modular ovens and the one or more modular support equipment platform such that the parts can travel there between as part of the part coating process. For example, the modularly integrated coating system 10 may thus be operable to apply a thin film of electrocoat primer to the part surfaces through the cathodic electrodeposition of parts. The modularly integrated coating system 10 may also comprise a paint recirculation device, operable to re-circulate paint through the modularly integrated coating system 10 (e.g., recycling used paint from a later stage to an earlier stage). The modularly integrated coating system 10 may include a cooling system supplied to maintain the paint bath temperature. For example, in some embodiments, the cooling system may comprise a plate and frame heat exchanger, using chilled water. The cooling system may also comprise other means of maintaining the paint bath at a desired temperature level as will be appreciated by one of ordinary skill. For more details on the coating process, U.S. Pat. No. 7,241,366 is incorporated by reference herein in its entirety.

When present, an anolyte system may comprise membrane electrode cells, anode distribution panels, anolyte tanks, circulating pumps, automatic conductivity controls, and/or a supply of purified water. The anolyte system may thereby provide a device having a ratio of effective electrode area to coated surface area as required by the particular application. The anolyte system may also comprise an anode distribution panel, anolyte tank, and recirculation system. The volume of the anolyte tank may be a minimum of two times the pump capacity, and at least the volume of the combined anolyte cells. However, other tank capacities are also contemplated. The anolyte tank may also comprise a conductivity meter that actuates a solenoid valve that allows the de-ionized water to enter the tank whenever the conductivity exceeds the set point.

The optional filtration system may comprise bag filters, ultra-filter casings, a pump, and a filter cleaning system. The bag filters may be located in line ahead of the ultra-filters to remove particular contamination and to protect the ultra-filters. The filtration system may individually isolate a particular filter to allow the rest of the system to run, while the particular filter may be cleaned. In one embodiment, the paint velocity through the piping system should be a minimum of at least 2.1 meters per second, and a maximum of 4.2 m/s. However, other filtration systems are also contemplated for use, suitable to eliminate a certain threshold of contaminants from the integrated coating system.

In some embodiments, the modularly integrated coating system 10 may comprise an integrated water heat generation system. In some embodiments, the water heat generation system may comprise a hot water or steam boiler 220 as illustrated in FIG. 1B. In such embodiments, the steam boiler 220 may be integrated into one or more modular support equipment platforms 200 such that when the modular support equipment platform 200 is delivered and installed, the water heat generation system is contemporaneously provided. The water heat generation system may also comprise a curing oven that may be used for both e-coat cure, for dry-off and cure during powder coating operations, or combinations thereof. The curing oven heating system may also be used as a hot water boiler system to supply process heat. In one embodiment, the oven may have two reconfigurable designs; one with heat generation and one without.

The modularly integrated coating system 10 may additionally comprise a waste water treatment system 320 integrated within the system. The waste water system may additionally comprise a range of treatment technologies, included but not limited to, metal removal system, ion exchange, or metal hydroxide precipitation. Additionally or alternatively, the modularly integrated coating system 10 may comprise a purified water system integrated within the system. The purified water system may produce a de-ionized water or purified water through various systems appreciated by one of ordinary skill. For example, the water purification system may comprise a revere osmosis system, or other water purification system.

The modularly integrated coating system 10 may comprise a water recycling and recovery system. The water recycling and recovery system may be operable to minimize or eliminate all liquid waste products. The water recycling and recovery system may be operable to recycle and remove all contaminants from the internal process water. The contaminants may be removed as solids, thus meeting the best available technology requirement of Europe. The water recovery and recycle system may comprise a water storage capability with the recycling option which minimizes the use of water for regions where water is scarce and/or expensive.

In some embodiments, an integrated process control system (e.g., an integrated lab kit module 330 and/or a process control system 340 as will become appreciated herein) may be provided in conjunction with the modularly integrated coating system 10. The integrated process control system may be integrated any plurality of locations about the modularly integrated coating system, or locations proximate thereto, to allow for the capturing, monitoring and/or adjustment of various data from the modularly integrated coating system 10, laboratory data, control data and other non-coating parameters. The integrated process control system may therefore control and monitor a plurality of process variables, including but not limited to, pH, conductivity, fluoride, ORP, temperature, flow, pressure, motor speed, line barcodes, lab barcodes, delta scope, direct input, lab test data, quality data, spc set up, tank parameters, cycle times, and fault response. It is contemplated that the integrated process control system may control monitor over 40 different process attributes.

The integrated process control system may produce a variety of outputs in terms of controllers; displays; handheld devices; alarms; and interface panels. For controllers, the outputs may comprise metering pumps, valves, switches, motors, and burners. For displays, the outputs may include process status, 3D equipment detail status, equipment operating parameters, process reports, and charts. For handheld outputs, the list may comprise process status, equipment warnings, notifications, instructions, and visual alarms. For alarms, the outputs may comprise warnings, notifications, instructions, and alarms. For the interface panel, outputs may comprise process status, 3D equipment detail status, equipment operating parameters, process reports, and charts. The integrated process control system be integrated with a globalized data management system.

In some embodiments, the modularly integrated coating system can optionally comprise an integrated lab kit module to provide testing capabilities (e.g., check part coating quality such as coverage, thickness, dryness, measure chemical values such as pH values, or test for any other testable property that can be used to monitor the part coating process) at one or more points along the modularly integrated coating system. In such embodiments, the integrated lab kit may be attached, connected to or otherwise integrated with the modularly integrated coating system to allow for the measurements of various parameters relating to the part coating process (temperatures, pH levels, concentrations, quality control parameters, etc.).

In some embodiments, the control system may be responsive to the integrated lab kit module. Specifically, if the lab kit module detects coating defects in the modularly integrated coating system, the lab kit may notify the user via a display unit or output of the control unit. Based on this output, the user may adjust one or more system parameters of the coating system via utilization of the control unit in order to correct the defect. Alternatively, the control unit may automatically adjust system parameters to correct the defect.

In some embodiments, the modularly integrated coating system 10 can provide a demand-rate optimized process to match the coating requirements and needs of the employing target facility. The modularly integrated coating system 10 may be configured to coat a variety of part sizes, and thus sized and dimensioned to accommodate the part size to be coated. The modularly integrated coating system may be operable to coat using a variety of coating technologies, including, but not limited to, electro-coating, powder coating, plating, or Aquence.

The modularly integrated coating system 10 disclosed herein may provide a coating system operable to provide corrosion protection for both ferrous and non-ferrous components, including but not limited to, stampings, castings, manufactured assemblies, and commercial components. It is also contemplated that the modularly integrated coating system 10 may provide coating functionality in conjunction with a variety of other components.

For example, in some embodiments, the modularly integrated coating system 10 may comprise a switch that allows a user to select the desired coating process, for example, electrocoating, powder coating, plating, Aquence, or, where possible, a combination thereof. In one embodiment, the modularly integrated coating system 10 may allow a user to utilize a variety of coating technologies, while utilizing a single pretreatment system and curing oven.

The modularly integrated coating system 10 may additionally be configured to be compatible with a variety of energy sources including, but not limited to, liquid propane and compressed natural gas.

Referring still to FIG. 4, the modularly integrated coating system 10 may also comprise a part handling system 300 operable to transport and handle the supplied parts throughout the different systems and unit operations. The part handling system 300 may include, but is not limited to, a monorail conveyor, a power and free conveyor, an indexing machine, a programmable hoist, and an indexing monorail. In addition, the part handling system 300 may be configured to connect seamlessly to all of the different systems in the modularly integrated coating system 10 such that when an additional modular piece is connected or installed, the part handling system 300 is easily connected and expanded to allow for transport to the newly added area.

Referring now to FIG. 5, an exemplary schematic layout 11 of a modularly integrated coating system comprising a plurality of coating support equipment 250 is illustrated wherein part movement is indicated by solid arrows, water flow is indicated by dashed arrows and data connection is indicated by dashed lines. The part coating process can generally comprise the steps of going through a part preparation station 302, a part coating station 304 and a part curing station 306 with possible rinse stations 301, 303 and 305 before and/or after each stage. While the schematic layout 11 depicts several separate possible rinse stations 301, 303 and 305, it should be appreciated that one or more rinse stations may be combined and that the runoff of one or more rinse stations may be recycled directly to an earlier rinse station.

As the parts progress between the different stages, the water heat generation system 310 can provide heated water when and where required, such as to the plurality of possible rinse stations 301, 303 and 305 as illustrated. As discussed above, the water heat generation system 310 can be a conventional stand alone water heat generation system, can be a boiler integrated with the modularly integrated coating system (such that it is predisposed on or about a modular support equipment platform 200), or can be integrated with a modular oven 100. The water heat generation system 310 can receive water from outside sources (such as public utility water or externally purified water) or internal recycling (such as recycled water from the water treatment system 320 as illustrated).

Moreover, the waste water (i.e., the water left over from the various processes such as the rinse stations) can be filtered and/or treated in the water treatment system 320 for recycling back to the water heat generation system 310 as illustrated. In some embodiments, water leaving the water treatment system 320 may additionally or alternatively be sent directly to the process stage where it is needed (bypassing the water heat generation system 310) or may be discarded external the modularly integrated coating system.

Still referring to FIG. 5, additional monitoring and testing controls can be provided directly within the modularly integrated coating system. For example, as illustrated, an integrated lab kit module 330 and/or a process control system 340 can be integrated within the modularly integrated coating system at one or more locations. The integrated lab kit module 330 and process control system 340 may be able to test, monitor and/or control one or more processing stages (e.g., the rinse stations 301, 303 and 305, the part preparation station 302, the part coating station 304 or the part curing station 306) or otherwise test, monitor and/or control the parts as they travel there between. Both the integrated lab kit module 330 and the process control system 340 may be integrated at any combination of locations in the modularly integrated coating system to allow for the monitoring of any desired parameter or control of any desired process.

In addition to being connected at one or more locations, the integrated lab kit module 330 and the process control system 340 may be able to communicate with one another so that the process control system 340 can automatically or manually control one or more parts of the modularly integrated coating system based on information received from the integrated lab kit module 330 as stated above. Likewise, in such embodiments, the integrated lab kit module 330 may specifically collect, test and/or analyze one or more parameters based on the actions or instructions from the process control system 340.

It should now be appreciated that modularly integrated coating systems may comprise a variety of user-selected options in a modular format to allow for the relatively quick and adaptable installation of preferred systems. Furthermore, modularly integrated coating systems can be easily transported, installed, modified and packed to provide low-cost individually selected coating machines.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A modularly integrated coating system for coating a plurality of parts, wherein the modularly integrated coating system comprises a part handling system that transports parts between:
one or more modular ovens configured to modularly connect to one another to form a single curing station of selectable size for curing the plurality of parts, wherein the one or more modular ovens comprise a gas burner and a circulating fan;
one or more modular support equipment platforms configured to stackably support the one or more modular ovens in the modularly integrated coating system, wherein the one or more modular support equipment platforms comprises:
a water treatment system configured to treat water utilized for coating the plurality of parts in the modularly integrated coating system;
a water heat generation system configured to provide heated water utilized in coating the parts;
an integrated lab kit module configured to provide testing capabilities at one or more points along the modularly integrated coating system;
an integrated process control system configured to monitor and control the coating of the plurality of parts as they progress through the modularly integrated coating system; and
a part coating system operationally integrated with the one or more modular ovens and the one or more modular support equipment platforms.

2. The modularly integrated coating system of claim 1, wherein a first end section comprises the circulating fan and a second end section opposite the first end section comprises a gas burner.

3. The modularly integrated coating system of claim 1, wherein the one or more modular ovens comprise a first end section, a second end section, and one or more middle extension sections disposed between the first end section and the second end section.

4. The modularly integrated coating system of claim 1, wherein the one or more modular support equipment platforms comprise the part coating system.

5. The modularly integrated coating system of claim 1, wherein a first end section of the modular oven comprises the circulating fan and a second end section of the modular oven opposite the first end section comprises a gas burner.

6. The modularly integrated coating system of claim 1, wherein each of the one or more modular ovens are modularly transportable.

7. The modularly integrated coating system of claim 1, wherein the one more support equipment platforms further comprise one or more rinse stations.

8. The modularly integrated coating system of claim 7, wherein the water treatment system treats water received from the one or more rinse stations.

9. The modularly integrated coating system of claim 8, wherein the water treated by the water treatment system is recycled to the water heat generation system.

10. The modularly integrated coating system of claim 1, wherein the water heat generation system is built into a boiler in the modularly integrated coating system.

11. The modularly integrated coating system of claim 1, wherein the part coating system coats the plurality of parts through electrocoating.

12. The modularly integrated coating system of claim 1, wherein the part coating system coats the plurality of parts through powder coating.

13. The modularly integrated coating system of claim 1, wherein the integrated lab kit module and the process control system communicate with one another so that the process control system can control one or more parts of the modularly integrated coating system based on information received from the integrated lab kit module.
